(19) United States
(12) Patent Application Publication
(10) Pub. No.: US 2024/0297388 A1
(43) Pub. Date: Sep. 5, 2024

(54) BATTERY ENERGY SYSTEM FOR INTERMODAL CONTAINERS

(71) Applicant: Green Intermodal Technologies LLC, Danville, CA (US)

(72) Inventor: Russell Chaplan, Danville, CA (US)

(21) Appl. No.: 18/593,270

(22) Filed: Mar. 1, 2024

Related U.S. Application Data
(60) Provisional application No. 63/488,442, filed on Mar. 3, 2023.

(51) Int. Cl. H01M 50/249; B60H 1/32; B62D 33/04; H01M 10/42; H01M 50/236; H01M 50/244; H02J 7/00; H02J 7/02

(52) U.S. Cl. CPC H01M 50/249; B62D 33/048; H01M 10/425; H01M 50/236; H01M 50/244; H02J 7/00036; H02J 7/0042; H02J 7/0047; H02J 7/0068; H02J 7/02; B60H 2001/3286; H01M 2010/4271; H01M 2220/20; H02J 2207/10; H02J 2207/20

(57) ABSTRACT

Battery energy systems having a housing and a battery management system for supplying power to a refrigerated container are disclosed. A battery management system includes a battery set, a battery management controller, an insulation monitoring device, a plurality of DC contactors, a DC/DC converter, a DC/DC controller, an inverter, an IoT gateway, a control panel, and a cooling system all interconnected. A battery energy system includes mounting brackets to mount the battery energy system to the nose or underside of a refrigerated container.

### RELATED APPLICATION INFORMATION

This patent claims priority from provisional patent application No. 63/488,442, filed Mar. 3, 2023, entitled BATTERY ENERGY SYSTEM FOR INTERMODAL CONTAINERS, the contents of which are included by reference in their entirety.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

Systems for powering intermodal containers having refrigeration are described herein. More specifically, the battery energy systems described herein relate to providing electrical power to refrigerated containers using lithium ion and other battery power units.

An intermodal container, often called a shipping container, is a large, standardized shipping container designed and built for intermodal temperature-controlled freight transport, meaning these containers can be used across different modes of transport—from ship to rail to truck—without unloading and reloading their cargo.

Intermodal containers are primarily used to store and transport materials and products efficiently and securely in the global containerized intermodal freight transport system, but smaller numbers are in regional use as well. Based on size alone, up to 95% of intermodal containers comply with ISO standards and can officially be called ISO containers.

The most prominent of the special-purpose intermodal containers are refrigerated containers (also called “reefers”) for perishable goods. Reefer containers make up approximately 6% of the world's shipping boxes.

Reefers do not cool themselves, and port charging stations, intermediate storage facilities and individual vehicles do not always have a reliable available power connection. Therefore, a generator is often the key component for refrigerated containers.

When a refrigerated container is picked up with a truck and chassis, a genset is needed to power the refrigeration unit to maintain the cold chain. These are customarily diesel-powered generators which may be nose mounted or belly mounted.

Generators come in a variety of styles. An Undermount Generator is firmly anchored to a truck's container chassis. This type of generator is suitable for refrigerated containers as well as for heating cargo. An undermount generator is especially suitable if you want to transport by frequently changing containers by truck. These are customarily 15 kW and are customarily diesel-fueled.

Clip-On generators can be also installed on the reefer container, therefore offering more flexibly. Mounting and replacement can be done within minutes. Thus, a clip-on generator is a good energy solution for refrigerated containers that are transported on ships, trucks, or rail, as well as for storage in places where no power connection is available. The weight of a clip-on generator is customarily about 800 kilograms, customarily provide 15 kW of electricity, and are typically diesel fueled.

Both types of generators are customarily installed with controllers and provide for remote monitoring, as well as a thermostat with optional servo functionality (temperature sensor transmitter). These gensets also customarily include support for wireless cell phone communications.

Customarily, a diesel reefer genset can run a container for 5 days without the need to refill fuel. The gensets are temporarily charged by the refrigeration battery charger when plugged in. These battery chargers are customarily solid-state battery chargers, often with a maximum of 12V DC batteries.

For convenience, environmental protection, reduced size, lower weight and increased efficiency, what is needed is a solid state or lithium ion battery system to replace the diesel fueling system of reefer gensets. The benefits are numerous. There are many environmental benefits to reducing the carbon footprint of intermodal container traffic. There are efficiencies gained by truckers not waiting in lines for gensets, helping improve turn times and reduce idling. Plus battery systems offer reduced maintenance or maintenance-free alternatives to diesel engine gensets that need constant service, oil, and filter changes, among others.

### BRIEF DESCRIPTION OF DRAWINGS

FIG. 1 is a front perspective view of a battery energy system.

FIG. 2A is a left perspective side view of the battery energy system mounted to a reefer container.

FIG. 2B is a top view of the battery energy system mounted to a reefer container.

FIG. 3 is a rear exploded view of the battery energy system.

FIG. 4 is a front view of the battery energy system.

FIG. 5 is a block diagram of the battery energy system.

FIG. 6 is an exemplar block diagram of batteries configured as a battery set of a battery management system.

FIG. 7 is a perspective view of an alternative embodiment of a battery energy system.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

Systems for powering intermodal containers having refrigeration are described herein. More specifically, the battery energy systems described provide electrical power to reefer gensets using lithium ion and other battery power units.

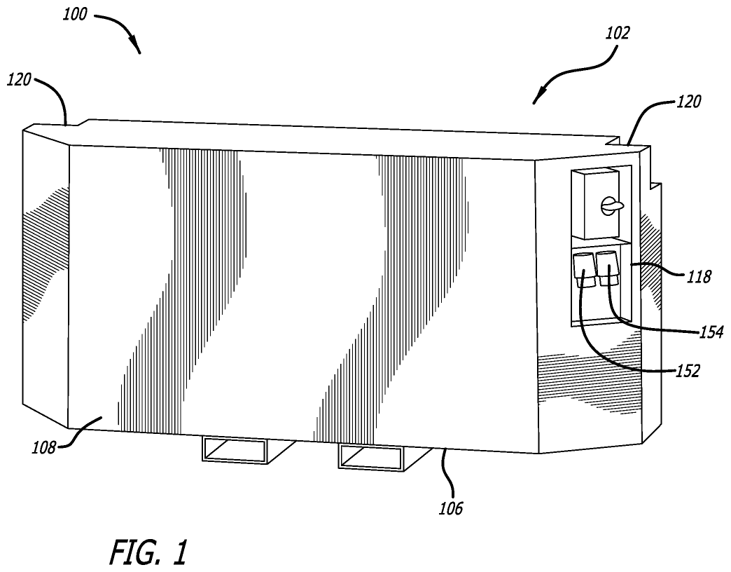

Referring now to FIG. 1, a battery energy system 100 consists of a housing 102 and a battery management system 130. The housing 102 is adapted to contain the battery management system 130 that may further have a battery set, a battery management system control box, a cooling system, an inverter, an internet of things (IoT) gateway, a control panel 150, an outlet receiver 152 and an inlet charging port 154.

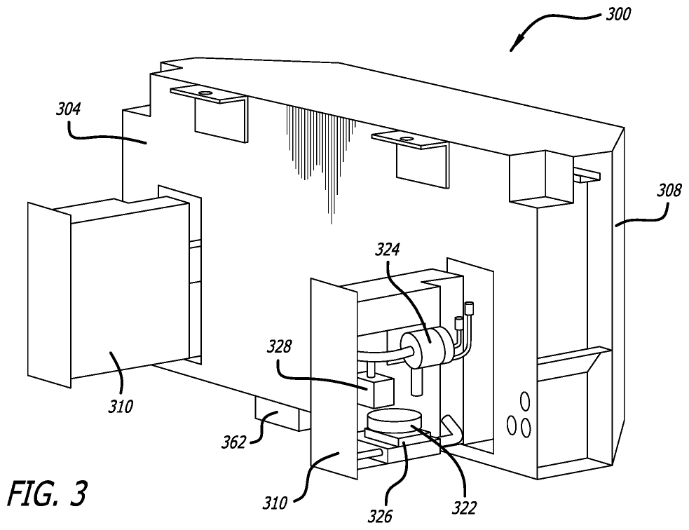

The housing 102 having a back wall 104 (see also FIG. 3, 304), a bottom wall 106, a front wall 108, and a cover 112. The back wall 104 extends downward into the bottom wall 106. The back wall 104 is joined to the bottom wall 106 through one of many methods such as, but not limited to, welding, or any other alternate method for securely fastening the back wall 104 to the bottom wall 106. The back wall 104 may also be removably secured to the bottom wall 106 with fasteners such as but not limited to nuts and bolts or other suitable alternative fastening method capable of securing the back wall 104 to the bottom wall 106. The back wall 104 and the bottom wall 106 are formed such that they may bear a substantial amount of weight of the battery energy system 100, such that the two walls together create a structurally rigid formation to support the various components of the battery energy system 100. Further, the back wall 104 is adapted to abut the front side, or nose, of a refrigerated storage container (“reefer container”).

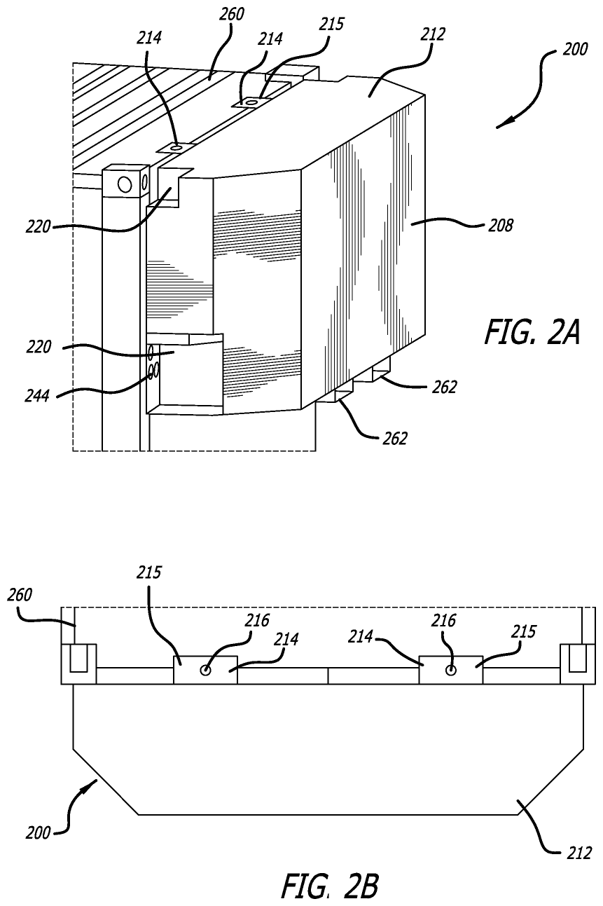

The bottom wall 106 extends outwardly from the back wall 104 a predetermined length and then extends diagonally inward a second predetermined length, into a straight edge. The front wall 108 extends upwardly from the bottom wall 106 equidistant to the back wall 104. The front wall 108 is joined to the bottom wall 106 by welding, or method for securely fastening the front wall 108 to the bottom wall 106. The front wall 108 may have at least one cutout 118 configured to receive the inlet charging port 154 and the outlet receiver 152. One of the at least one cutout 118 may also be adapted to receive the control panel 150. Further, the front wall 108 may also have a plurality of access carveouts 120. The plurality of access carveouts 120 may be positioned, such that a person installing the energy battery system 100 can easily fasten the energy battery system 100 to the reefer container (see also FIG. 2A).

The cover 112 extends from the back wall 104 to the front wall 108 and is formed to create an enclosure for the contents of the battery management system 130. The cover 112 may extend into the front wall 108, such that the cover forms a portion of the front wall 108. A benefit of having cover 112 is that it allows ease of access to the contents of the housing 102 without the need for dismantling the battery energy system 100 completely. Further, the cover 102 may be secured by a hinge to the back wall 104, such that the cover 112 may pivot about the back wall 104 to expose the contents within the housing 102 to the atmosphere.

The housing 102 is adapted to enclose the various elements of the battery management system 130 and may be configured in various shapes such as but not limited to: semi-heptagon, crescent, square, half-dome, or other suitable formations capable of enclosing the various elements of the battery energy system 100. The benefits of the crescent shape are such that when the battery energy system 100 is mounted to the reefer container it may subsequently be connected to a semi-truck. For example, the general crescent shape allows for proper clearance between the reefer container and the semi-truck towing the reefer container wherein the battery energy system 100 is interposed.

On the exterior of the front wall 108 is the control panel 150. The control panel 150 may be mounted to any point about the front wall 108 or may alternatively be mounted to the side wall 110. A benefit of placing the control panel 150 on the exterior of the housing 102 is ease of accessibility. Further, mounting the control panel 150 on the left side of the housing 102 permits ease of access for a semi-truck driver when the reefer container connected with the battery energy system 100 is being towed. For example, the semi-truck driver need only step out of the semi-truck cab and walk a short distance to access the control panel 150. The right side may similarly be used in other truck markets.

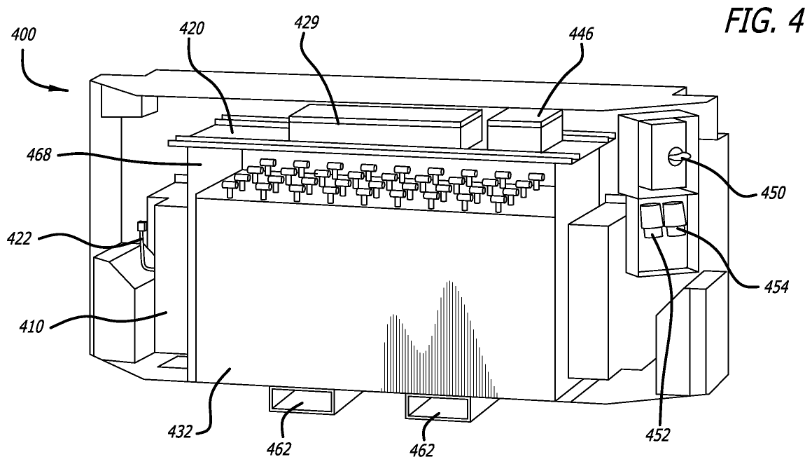

Coupled to the bottom wall 106 is a set of forklift pockets 162 (see also FIG. 2A element 262; FIG. 3 element 362; and FIG. 4 element 462). The set of forklift pockets 162 have a pair of pocket side walls 164 equally distanced from each other that extend downward from the bottom wall 106 into a pocket bottom wall 166. The bottom wall 106, the pair of pocket side walls 164 in conjunction with the pocket bottom wall 166 form the set of forklift pockets 162. The set of forklift pockets 162 extend the length of the bottom wall 106. The set of forklift pockets 162 are spaced apart at a predetermined distance. The set of forklift pockets 162 are formed to receive the forks of a standard forklift. For example, the battery energy system 100 may be mounted using a forklift capable of withstanding the weight of the battery energy system 100, lifting the battery energy system 100 upward, such that it may be mounted to the reefer container 160.

The housing 102 may be made from materials such as but not limited to aluminum, metal, or other suitable material capable of bearing the weight of the battery energy system 100.

Now referring to FIGS. 2A-2B, a battery energy system 200 is the same as the battery energy system 100 of FIG. 1. Extending from a back wall 204 are at least two brackets 214. The at least two brackets 214 may be removably secured to the back wall 204 with fasteners (see also FIG. 3 element 314). The at least two brackets 214 may also be fixed to the back wall 204 such that they are joined to the back wall 204. The at least two brackets 214 extend upward from the back wall 204 and outwardly away from the back wall 204. The at least two brackets 214 extend outwardly over a portion of the reefer container 260 a length sufficient to secure the battery energy system 200, such that the at least two brackets 214 create a lip 215. Centrally located to the lip is a mounting bore 216. The lip 215 of the at least two brackets 214 extends over a reefer container 260 wherein the mounting bore 216 is interposed between the reefer container 260 and a fastener (not shown). The fastener may be but is not limited to: nut and bolt, axle pin, screw fastener, retractable twist-lock or any other suitable fastener capable of removably securing the battery energy system 200, to the reefer container 260. The battery energy system 200 may further be secured to the reefer container 260 through a plurality of mounting apertures 244. The plurality of mounting apertures 244 are bored through the back wall 204. The plurality of mounting apertures 244 are accessible through one of a plurality of access carveouts 220.

The battery energy system 200 may be mounted to the reefer container 260 in various locations. For example, the battery energy system 200 may be mounted to the nose, belly, or other suitable location of the reefer container 260 wherein the battery energy system 200 may supply power to the reefer container 260. “Nose” means the front side/wall of the reefer container 260. “Belly” (also referred to as “underslung”) means the underside/bottom of a chassis atop which the reefer container 260 is attached. The battery energy system 200 may be mounted onto the reefer container 260 through any combination of and between the at least two brackets 214, the plurality of mounting apertures 244 accessible through one of a plurality of access carveouts 220 and fasteners. For example, the battery energy system 200 may be belly mounted to a chassis onto which the reefer container 260 is mounted, wherein the battery energy system 200 may be mounted to the chassis with fasteners through the plurality of mounting apertures 244 and/or the at least two brackets 214. It is to be understood that the battery energy system 200 may have alternative embodiments such that alternative mounting positions are achievable.

Now referring to FIG. 3, a battery energy system 300 is shown, the battery energy system 300 is the same as the battery energy system 100 shown in FIG. 1. The battery energy system 300 may have at least one slide out 310. The at least one slide out 310 is bored from a back wall 304. The at least one slide out 304 may be a box or drawer-like enclosure to house various components of the battery energy system 300. For example, in one present embodiment, one of the at least one slide outs is adapted to house a cooling system 322 further having a pump 324, a cooling unit 326, and a coolant reservoir 328. The at least one slide out 310 when inserted from the back wall 304 abuts a front wall 308, and when fully interested into the battery energy system 300 forms a portion of the back wall 304.

A benefit of having the at least one slide out 310 is ease of access of enclosed components within the at least one slide out 310. For example, if there is service needed with the cooling system 326, a person need only remove the at least one slide out 310 containing the cooling system 326 to conduct service repairs instead of completely dismantling the battery energy system 300 to gain access.

Now referring to FIG. 4, an exemplar of the interior a battery energy system 400 component configuration is shown. The battery energy system 400 is the same battery energy system 100 as shown in FIG. 1 showing the interior thereof. FIG. 4 depicts a housing 402 for the battery energy system 400 having a front wall 408 (transparent for illustrative purposes), having a bottom wall 406 and a back wall 404. The housing 402 is adapted to contain the battery management system 430 which includes: a battery management system (“BMS”) control box 429, an inverter 446, a battery set 432, a control panel 450, a cooling system 422, an internet of things (IoT) Gateway, an outlet receiver 452, and an inlet charging port 454. Centrally located to the housing 402 is the battery set 432. The battery set 432 is enclosed by two battery side walls 468 and a battery top wall 470. Removably secured atop the battery top wall 470 may be the inverter 446 and the BMS control box 429. Adjacent to and on either side of the battery side walls 468 may be at least one slide outs 410. Housed in one of the at least one slide outs 410 is the cooling system 422. Located on the exterior of the front wall 408 is the control panel 450, the outlet receiver 452 and the inlet charging port 454. The battery energy system 400 may have alternative configurations wherein each of the components may be positioned in alternative locations throughout the housing 402. For example, the battery set 432 may be moved to the far right or left side of the housing such that the cooling system 422, the inverter 446, and the BMS control box 429 are on opposite sides to reduce the general size of the battery energy system 430. Furthermore, the battery management system 430 is grounded from the housing 402 for increased safety and handling of the battery energy system 400.

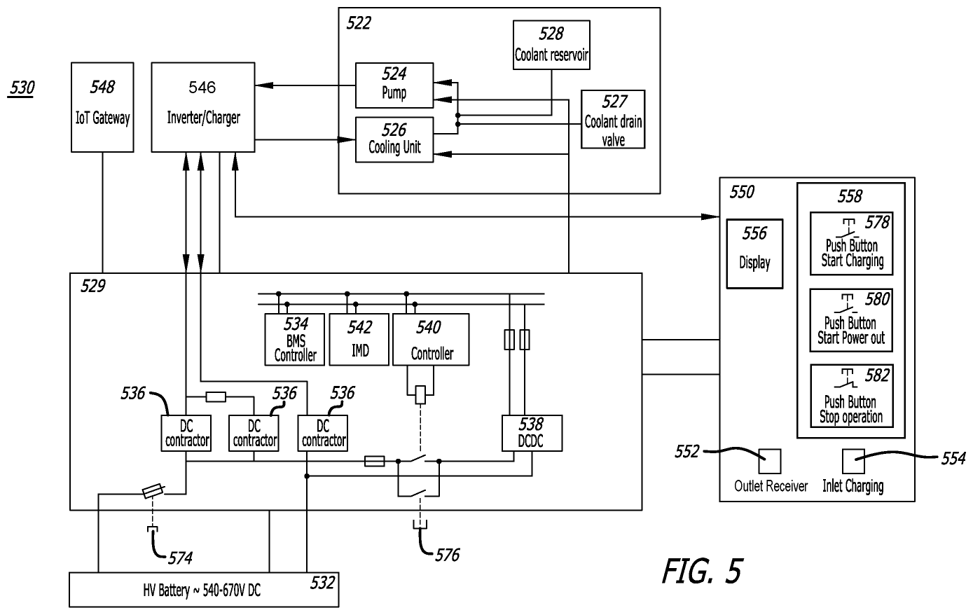

Now referring to FIG. 5, a block diagram of a battery management system 530 of a battery energy system 500 is shown. The battery energy system 500 is the same battery energy system 100 as shown in FIG. 1. The battery management system 530 includes: a battery management system (“BMS”) control box 529, an inverter 546, a battery set 532, a control panel 550, a cooling system 522, an internet of things (IoT) Gateway 548, an outlet receiver 552 and an inlet charging port 554.

The BMS control box 529 may contain a BMS controller 534, an insulation monitoring device (IMD) 542, a DC/DC controller 540, a DC/DC converter 538, at least three DC contactors 536. The BMS controller 543 is responsible for handling the input and output signals for the battery management system 530 generally. The insulation monitoring device (IMD) 542 is for continuously monitoring the insulation resistance of the battery energy system 500. The DC/DC controller 540 is responsible for handling the input and output signals for the DC/DC converter. The DC/DC controller 540 is connected to a relay 572. The DC/DC converter 538 is for converting one DC voltage to another DC voltage. The at least three DC contactors are for opening and disconnecting the DC circuits. Each of the components of the BMS control box 529 are electrically connected and may further include predetermined fuses interposed between connections for various operable configurations. Additionally, the BMS control box 529 may have a manual service disconnect 574 such that the connection between the BMS control box 529 and the battery set 532 can be manually disconnected. The manual service disconnect 574 may be positioned on the exterior of the battery energy system 500 for ease of access by a person. The BMS controller 543 may also have a push button 576 to power on the battery energy system 500. The push button 576 connects and/or disconnects the relay between one of the power terminals of the battery set 532 and the DC/DC converter 538 and DC/DC controller 540. The push button 576 may also be positioned on the exterior of the battery energy system 100 for ease of access by a person.

Connected to the BMS control box 529 is the inverter 546. The inverter 546 is responsible for converting the high voltage DC power from the battery set 532 into conventional AC power used to power the reefer container. The inverter 546 may convert the 540 to 670 volt DC power from the battery set 532 into a power output of 400 volt AC. The benefit of utilizing the inverter 546 with battery management system 530 is the elimination of low voltage batteries typically needed to power components such as but not limited to the BMS control box 529, and/or the cooling system 522 as the battery energy system 500 can draw power from the battery set 532 and utilize converted AC power.

The inverter 546 may also be connected to the control panel 550. The control panel consists of an outlet receiver 552 and an inlet charging port 554. The outlet receiver 552 supplies the power from the inverter 546 to the reefer container. Additionally, the battery set 532 may be charged from an external power supply using the inlet charging port 554. The external power supply provides AC power to the inverter 546 which converts the AC power to DC power and supplies the energy back to the battery set 532. When an external power supply is connected to the battery energy system 500 when the battery energy system 500 is connected to the reefer container, the battery management system 530 is capable of simultaneously powering the reefer container and charging the battery set 532. A benefit of simultaneously charging the battery energy system 500 and the reefer container is that the battery energy system 500 can remain mounted to the reefer container and needs only one connection point through the inlet charging port 554.

The control panel 550 may also connected to the BMS control box 529 to communicate with manual switches in the control panel 550. The control panel 550 may have a display 556, and a switch box 558. The display 556 may provide user prompts to provide information on the battery energy system 500 status to users of the system. For example, the display 556 may notify the user when the battery energy system 500 is supplying power to the reefer container 560 or when the battery set 532 needs charging. The switch box 558 may further have a “charging” push button 578 to control when to charge the battery set 532, a “power out” push button 580 to control when the battery energy system 500 supplies power, and a “stop” push button 582 to shut down all operations of the battery energy system 500. Although shown and described as push buttons, other input receiving devices may be used such as a touch pad or other tactile or haptic input receiving devices or sensors.

Connected to the BMS control box 529 is the cooling system 522. The cooling system 522 may have a pump 524, a cooling unit 526, a coolant drain valve 527 and a coolant reservoir 528. The cooling system 522 is fluidly connected to the invertor 546 to prevent overheating of the invertor 546 during operation. For example, when in operation the invertor 546 may experience increased temperatures as a result of the AC to DC power conversion which may exceed tolerable temperatures. The cooling system 522 pumps coolant from the coolant reservoir over the inverter 546 to reduce the temperature of invertor 546. The coolant is thereafter reduced in temperature by the cooling unit 526 as the coolant's temperature may rise through contact with the invertor 546.

Also connected to the BMS control box 529 is the internet of things (“IoT”) Gateway 548 or other communication module. The IoT Gateway 548 may transmit and receive wireless connections through, but not limited to: WIFI, Bluetooth®, Zigbee®, cell phone such as GSM, RF sensors or other suitable methods of wireless communication. The IoT Gateway 548 provides a person the ability to remotely control the battery energy system 500 and may further provide system status to a user. The IoT Gateway may be another more specific or more general communication module that provides for a single or plurality of wireless communications including Bluetooth®, Zigbee®, WIFI, cell phone, and others. Lastly, the BMS control box 529 is connected to the battery set 532.

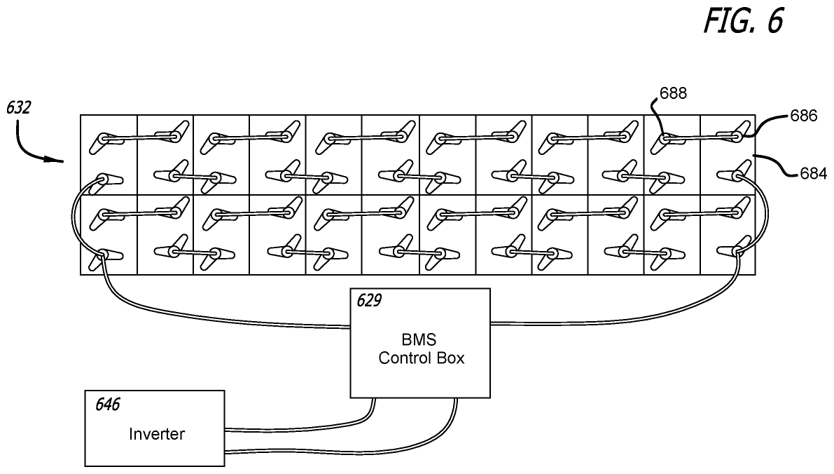

Now referring to FIG. 6, a battery set 632 (or any of the battery sets referenced herein) may include a plurality of batteries 684. The plurality of batteries having a positive terminal 686 and a negative terminal 688 which are connected in series. The plurality of batteries 684 are oriented and aligned such that the positive terminal 686 may be connected to the negative terminal 688 of a subsequent battery in the plurality of batteries 684. The plurality of batteries 684 are then connected to a BMS control box 629 and subsequently connected to an inverter 646. The BMS control box 629 and the inverter 646 is the same as the BMS control box 529 and the inverter 546 as discussed in FIG. 5. A benefit of connecting the plurality of batteries 684 in series is increased voltage output. The plurality of batteries 684 may be commercially available or custom made. The plurality of batteries 684 may be lithium ion or any suitable type of battery that is capable of supplying power to the battery energy system. Other battery options include lithium polymer, sodium-ion, or nickel-metal hydride batteries.

The battery energy system is capable of supplying an output power of 15 kW to reefer containers to maintain an ambient temp range between −40° to +52° C. (−40 to +125° F.). The battery energy system 100 is capable of operating in outdoor ambient from −50° C. to +50° C. (−58° F. to +125° F.). The battery energy system is configured to supply a voltage between 440 to 460 volts and may include 208/230-volt transformers. The battery energy system may run on 50 to 60 Hz. The battery energy system is grounded having circuit breakers with a minimum of 30 amps up to 50 amps.

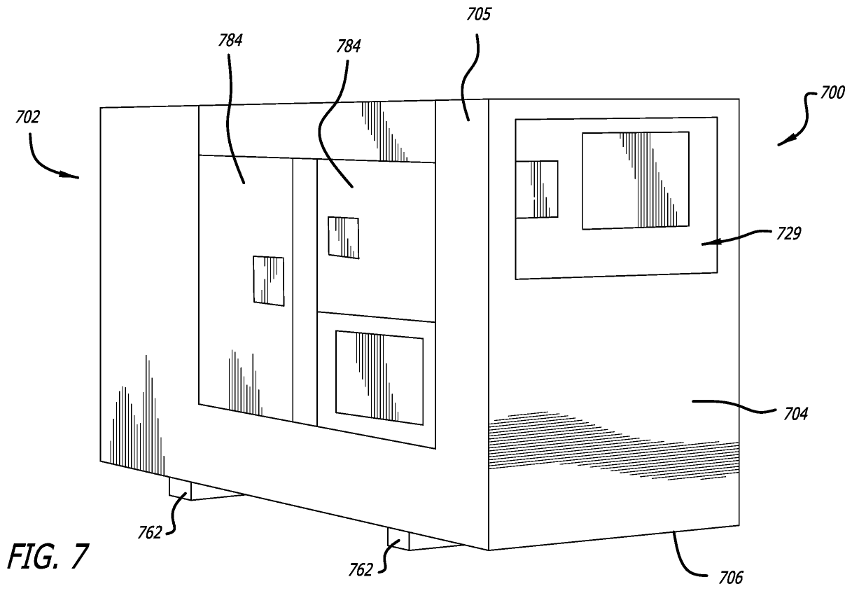

Referring now to FIG. 7, depicting a battery energy system 700, the battery energy system 700 is the same battery energy system 100. The battery energy system 700 has a housing 702 adapted to contain the various components of the battery energy system 700. The housing 702 may have a back wall 704 extending upwardly from a bottom wall 706. Extending outwardly from the back wall 704 may be a set of side walls 705. The housing 702 may then be enclosed by a front wall 708, that extends from either one of the set of side walls 705. The battery energy system 700 may also have a set of forklift pockets 762 that extend downward from the bottom wall 706. The set of forklift pockets 163 span the length of the bottom wall 706.

The housing 702 is adapted to contain the battery management system, not shown as it is included internal to the housing 702. The battery management system includes: a battery management system (“BMS”) control box 729, an inverter, a battery set, a control panel, a cooling system, and an internet of things (IoT) Gateway like those described herein above. The battery management system may be configured in various layouts. For example, the battery set of the battery management system may be placed centrally to the housing 702, wherein the cooling system is placed adjacent to the battery set, and the BMS control box 729, and the inverter are placed atop the battery set. It is to be understood that the components of the battery management system may be configured in alternative variations to permit alternative embodiments. The battery energy system 700 may also have access panels 784. The access panels 784 are mounted to the exterior of the front wall 708. The access panels 784 permit ease of access to components enclosed within the housing 702. For example, the access panel 784 may permit access to the cooling system where a person can maintain the cooling system without dismantling the battery energy system 700 altogether.

### CLOSING COMMENTS

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements, and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A battery energy system comprising:
a battery management system comprising a battery set, a battery management controller, an insulation monitoring device, a plurality of DC contactors, a DC/DC converter, a DC/DC controller, an inverter, an Internet of Things (IoT) gateway, a control panel, and a cooling system;
a housing, the housing having a substantially rigid back and a substantially rigid bottom for supporting the battery energy system, and having at least two brackets each having a centrally located connection point adapted to receive a fastener;
wherein the housing is adapted to contain the battery management system.

2. The battery energy system of claim 1, wherein the control panel comprises an outlet receiver, an inlet charging port, a display and a switch box.

3. The battery energy system of claim 1, the cooling system comprises a pump, a cooling unit, and a coolant reservoir.

4. The battery energy system of claim 1, wherein the cooling system is adapted to control the ambient temperature of a reefer container.

5. The battery energy system of claim 2, wherein the cooling system is capable of maintaining the ambient temperature between −40 degrees Celsius and +52 degrees Celsius.

6. The battery energy system of claim 1, wherein the battery energy system is configured to supply the reefer container with up to 15 kW of power.

7. The battery energy system of claim 1, wherein the battery energy system is a three-phase electrical system.

8. The battery energy system of claim 5, wherein the three-phase electrical system is capable of supplying a voltage output ranging from 200 volts up to 460 volts.

9. The battery energy system of claim 1, wherein the IoT Gateway is configured to provide wireless connectivity with the battery energy system.

10. The battery energy system of claim 7, wherein the IoT Gateway is configured to provide real-time system status.

11. The battery energy system of claim 1, wherein the switch box permits manual control of the battery energy system and includes real-time system status gauges.

12. The battery energy system of claim 1, wherein the operators comprise at least two selected from the group including pushbuttons adapted to start and stop the battery energy system operations, a contactor, a plurality of relays, and a plurality of fuses.

13. The battery energy system of claim 1, wherein the fastener is a two-axle pin.
